(19) United States
(12) Patent Application Publication
(10) Pub. No.: US 2005/0225271 A1
(43) Pub. Date: Oct. 13, 2005

(54) Configuration of inverter switches and machine coils of a permanent magnet machine

(75) Inventors: Mohammad N. Anwar, Van BurenTwp., MI (US); Mehrdad Teimor, Troy, MI (US); Daryl A. Wilson, Ypsilanti, MI (US); Paul F. Turnbull, Canton, IL (US); William Turnbull, Ypsilanti, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/821,674

(22) Filed: Apr. 9, 2004

(51) Int. Cl. H02P 5/06

(52) U.S. Cl. 318/254

(57) ABSTRACT

An inverter switch circuit for a permanent magnet machine is provided. Inverter switch circuit has two or more half bridge switch circuits per phase in communication with an equal number of machine coils per phase, of the permanent magnet machine. Each half bridge circuit includes a first and second power switch in electrical series connection. Further, each half bridge circuit is in electrical connection with each machine coil, thereby providing multiple parallel half bridge circuits for each phase.

### BACKGROUND

1. Field of the Invention

The present invention generally relates to a inverter switch circuit and machine coil configuration for a permanent magnet machine.

2. Description of Related Art

Many inverter switch circuits have been designed for interfacing with permanent magnet machines. Permanent magnet machines (PM) may require a large driving current based on the application and performance parameters of the PM machine. If the PM machine requires a high current draw, special high current electronic components must be used. Often, the high current components must be located on a separate board from low power electronics to minimize radio frequency interference and provide for proper heat dissipation.

One solution for providing higher current flow to PM machines while utilizing low power electronic components includes using several smaller discrete components in a parallel configuration to provide sufficient current flow to operate the PM machine. The parallel configuration allows the use of more commercially available components and reduces the overall cost of the electronics. In addition, the heat dissipation can be spread across multiple components allowing for a shared circuit board between the inverter switch circuit and other low power electronics. Further, smaller parallel power switches provide better flexibility to integrate the motor and inverter in one enclosure to provide improved space optimization.

However, one problem encountered with parallel power switches is that current sharing problems may arise. Even with matching the characteristics of the power switches, the power switches may not turn on or off at exactly the same time. The switching delay between the parallel power switches forces one of the power switches to carry much more than the maximum rated current during the delay time. The current through the switch that turns on earlier will be twice the normal current. This will cause more heat on the early power switch and will eventually damage the switch. The unequal sharing of current between parallel power switches, even for a short time, may cause power switch failures and ultimately destroy the inverter itself. The damage of the power switch overloads the next switch in parallel, and so on, creating a chain reaction until the whole inverter is destroyed. Breakdown may be stopped, if the fault can be detected and the inverter can be shut down very quickly. However, it is very difficult to detect and shut off the inverter in time. Another way to prevent breakdown of the power switches is to choose oversize components and heat sinks. However, using oversized components negatively affects cost and assembly complexity of the circuit

In view of the above, it is apparent that there exists a need for an improved inverter switch circuit for a permanent magnet machine.

### SUMMARY

In satisfying the above need, as well as overcoming the enumerated drawbacks and other limitations of the related art, the present invention provides an inverter switch circuit for a permanent magnet machine. Inverter switch circuit has two or more half bridge switch circuits per phase in communication with an equal number of machine coils per phase, of the permanent magnet machine. Each half bridge circuit includes a first and second power switch in electrical series connection. Further, each half bridge circuit is in electrical connection with each machine coil, thereby providing multiple parallel half bridge circuits for each phase.

In another aspect of the present invention, each half bridge circuit is in electrical connection with a machine coil between the first and second power switch. Preferably, each of the power switches are N-channel MOSFETs.

In another aspect of the present invention, the power source is connected to the source of the first power switch of each half bridge circuit. Further, the drain of the first power switch of each half bridge circuit is connected to the source of the second power switch of each half bridge circuit. To complete the circuit, the drain of the second power switch of each half bridge circuit is connected to a second side of the power source.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a schematic of an inverter switch circuit for a permanent magnet machine in accordance with the present invention; and

FIG. 2 is a schematic of an inverter switch circuit for a 3 phase, 9 slot, 6 pole permanent magnet machine in accordance with the present invention.

### DETAILED DESCRIPTION

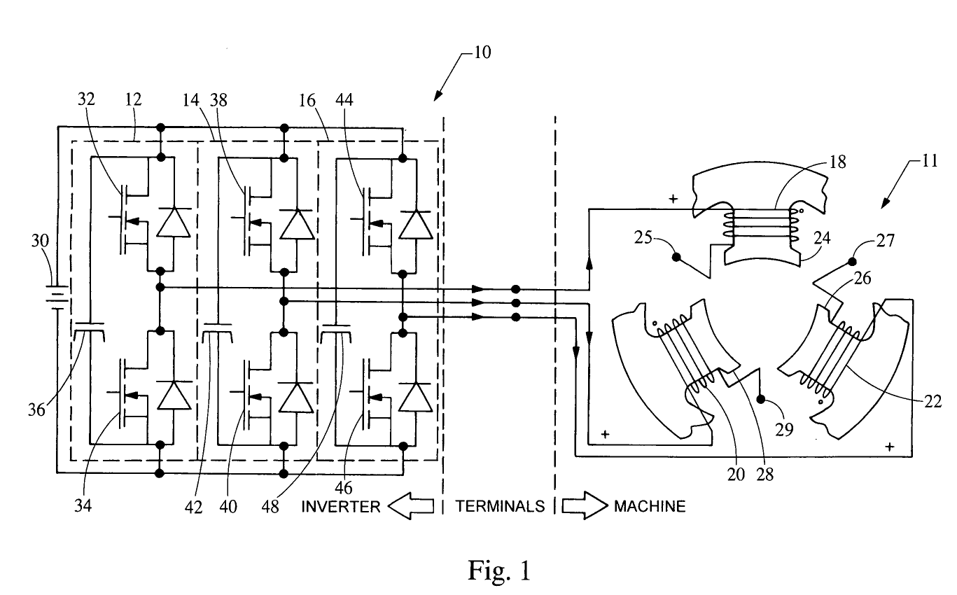

Referring now to FIG. 1, an inverter switch circuit for controlling a permanent magnet machine and embodying the principles of the present invention is provided. The inverter switch circuit includes a first switch circuit 12, a second switch circuit 14, a third switch circuit 16, and a power source 30. The permanent magnet machine 11 has multiple phases including three machine coils 18, 20, and 22 per phase. Each machine coil 18, 20, and 22 are wrapped around a magnetic core 24, 26, 28. One side of each of the coils 18, 20, 22 is tied to a common node 25, 27, 29, each common node being connected to a machine coil from each of the other phases. The other side of each of the coils 18, 20, 22 is tied to its respective switch circuit 12, 14, 16. For example, the first machine coil 18 is connected to the first switch circuit 12, the second machine coil 20 is connected to the second switch circuit 14, and the third machine coil 22 is connected to the third switch circuit 16. Each of the switch circuits 12, 14, and 16 acts in parallel as an individual half bridge power switch for each individual machine coil 18, 20, 22. By paralleling each half bridge configuration, reliability and fault tolerance of the overall circuit is improved.

The first switch circuit 12 includes a first power switch 32 and a second power switch 34. The first and second power switches, 32, 34 are provided in electrical series connection. Preferably, the first and second power switches are N-channel MOSFETs and, therefore, include an internal body diode. The drain of power switch 32 is connected to one side of the power source 30. The source of power switch 32 is connected to the drain of power switch 34 and the first machine coil 18. To complete the circuit, the source of power switch 34 is connected to the second side of the power source 30. The gate of power switch 32 and 34 are connected to a gate driver (not shown). Further, a capacitor 36 is provided in electrical parallel connection between the drain of power switch 32 and the source of power switch 34 to reduce parasitic bus inductance and reduce switching transients.

The second switch circuit 14 includes a third power switch 38 and a fourth power switch 40. The third and fourth power switches 38, 40 are provided in electrical series connection. Preferably, the third and fourth power switches are N-channel MOSFETs and, therefore, include an internal body diode. The drain of the third power switch 38 is connected to one side of the power source 30. The source of the third power switch 38 is connected to the drain of the fourth power switch 40 and the second machine coil 20. To complete the circuit, the source of the fourth power switch 40 is connected to the second side of the power source 30. The gate of the third and fourth power switch 38 and 40 are connected to the gate driver. Further, a capacitor 42 is provided in electrical parallel connection between the drain of the third power switch 38 and the source of the fourth power switch 40 to reduce parasitic bus inductance and reduce switching transients.

The third switch circuit 16 includes a fifth power switch 44 and a sixth power switch 46. The fifth and sixth power switches, 44, 46 are provided in electrical series connection. Preferably, the fifth and sixth power switches are N-channel MOSFETs and, therefore, include an internal body diode. The drain of the fifth power switch 44 is connected to one side of the power source 30. The source of the fifth power switch 44 is connected to the drain of the sixth power switch 46 and the third machine coil 22. To complete the circuit, the source of the sixth power switch 46 is connected to the second side of the power source 30. The gate of the fifth and sixth power switch 44 and 46 are connected to the gate driver. Further, a capacitor 48 is provided in electrical parallel connection between the drain of the fifth power switch 44 and the source of the sixth power switch 46 to reduce parasitic bus inductance and reduce switching transients.

With the configuration as shown, the operation and current through each coil and half bridge, as well as, the corresponding power switches do not depend on the current through the other coils and their corresponding switches. Here, the overall drive system works as if the three Y-connected machines are operating in parallel and completely independent to each other. The current through each switch is limited by Rₚ (phase resistance of each coil), whereas, if the power switches were positioned discretely in parallel, the resistance would be Rₚ/3 (three coils in parallel). Therefore, if the power switches of one side are not turned on exactly at the same time, the current through the early power switch will not exceed its designed limit. For this short period of time, when all of the machine coils are not energized at the same time, the machine may suffer from load unbalance and its performance may be compromised. The machine may produce less torque for this short period having more torque ripples. However, the load unbalance is not a significant issue due to the short duration and considering the reliability benefits provided by this configuration.

In addition, each half bridge power switch module can include a DC link capacitor in close proximity to the switches and coils. Further, the same capacitor can be used for effective DC line filtering, as well as, for snubbing the switch off transients of the corresponding switches. Possible packaging improvements may also be achieved utilizing this configuration. The DC link capacitors can be connected within a close proximity providing better filtering characteristics.

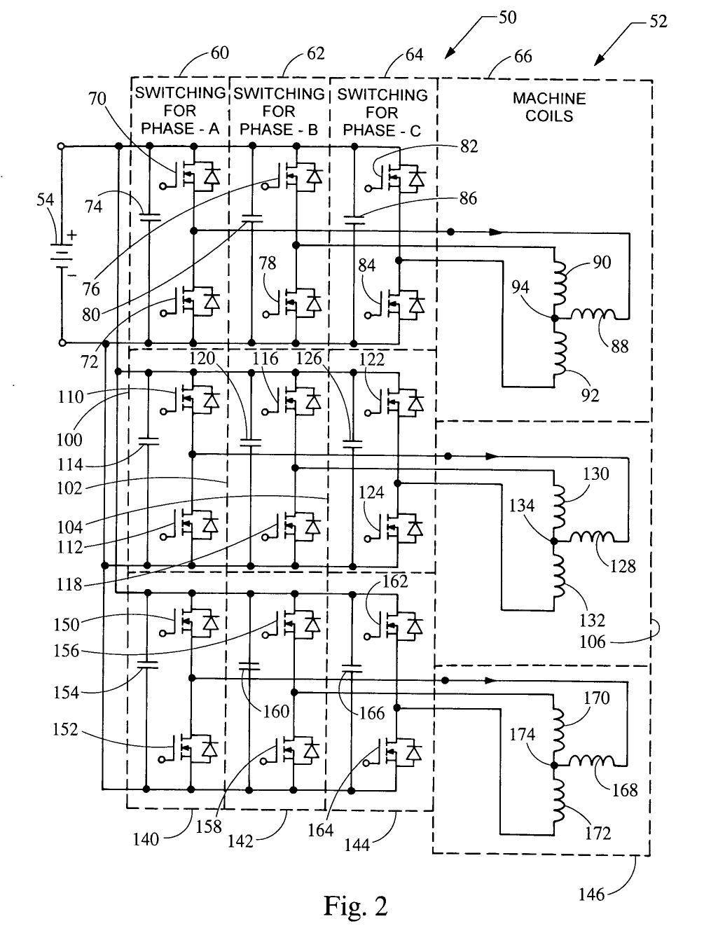

Now referring to FIG. 2, a further example is provided using a permanent magnet machine 52 in a three phase, nine slot, six pole configuration. As shown, the inverter circuit 50 includes nine individual half bridge configurations, one for each machine coil of the permanent magnet machine 52. Switch circuits 60, 100 and 140 provide switching for phase A. Switch circuits 62, 102, 142 provide switching for phase B. While switching for phase C is provided by switch circuits 64, 104, 144.

Switch circuits 60, 62, 64 provide the switching for phase A, B, and C, respectively, for a first Y-coil configuration 66 of the permanent magnet machine 52. In switch circuit 60, power switch 70 and 72 are in electrical parallel connection to form a half bridge configuration. Preferably, power switches 70 and 72 are N-channel MOSFETs, thereby including a body diode. However, other power switches including P-channel MOSFETs and even other complex switch combinations such as IGBTs and the like may be utilized.

The drain of power switch 70 is connected to the positive site of power source 54. The power source 54, generally a battery in automotive applications, provides power for each of the switch circuits. The phase A machine coil 88 of the Y configuration 66 is connected to switch circuit 60 between power switch 70 and power switch 72. The source of power switch 72 is connected to the negative side of the power source 54 completing the switch circuit 60. In addition, capacitor 74 is connected in parallel with power switch 70 and power switch 72.

In switch circuit 62, power switch 76 and 78 are configured in electrical parallel configuration to form a half bridge circuit. Preferably, power switches 76 and 78 are N-channel MOSFETs thereby including a body diode. However, other power switches including P-channel MOSFETs and even other switch combinations such as IGBTs and the like may be utilized. The drain of power switch 76 is connected to the positive site of power source 54. The phase B machine coil 90 of the Y configuration 66 is connected to switch circuit 62 between power switch 76 and power switch 78. The source of power switch 78 is connected to the negative side of the power source 54 completing the switch circuit 62. In addition, capacitor 80 is connected in parallel with power switch 76 and power switch 78.

In switch circuit 64, power switch 82 and 84 are configured in electrical parallel configuration to form a half bridge circuit. Preferably, power switches 82 and 84 are N-channel MOSFETs thereby including a body diode. However, other power switches including P-channel MOSFETs and even other switch combinations such as IGBTs and the like may be utilized. The drain of power switch 82 is connected to the positive side of power source 54. The phase C machine coil 92 of the Y configuration 66 is connected to switch circuit 64 between power switch 82 and power switch 84. The source of power switch 84 is connected to the negative side of the power source 54 completing the switch circuit 64. In addition, capacitor 86 is connected in parallel with power switch 82 and power switch 84.

Switch circuits 100, 102, 104 provide the switching for phase A, B, and C, respectively, for a second Y-coil configuration 106 of the permanent magnet machine 52. In switch circuit 100, power switch 110 and 112 are in electrical parallel connection to form a half bridge configuration. Preferably, power switches 110 and 112 are N-channel MOSFETs, thereby including a body diode. However, other power switches including P-channel MOSFETs and even other complex switch combinations such as IGBTs and the like may be utilized.

The drain of power switch 110 is connected to the positive side of power source 54. The phase A machine coil 128 of the Y configuration 106 is connected to switch circuit 100 between power switch 110 and power switch 112. The source of power switch 112 is connected to the negative side of the power source 54 completing the switch circuit 100. In addition, capacitor 114 is connected in parallel with power switch 110 and power switch 112.

In switch circuit 102, power switch 116 and 118 are configured in electrical parallel configuration to form a half bridge circuit. Preferably, power switches 116 and 118 are N-channel MOSFETs thereby including a body diode. However, other power switches including P-channel MOSFETs and even other switch combinations such as IGBTs and the like may be utilized. The drain of power switch 116 is connected to the positive site of power source 54. The phase B machine coil 130 of the Y configuration 106 is connected to switch circuit 102 between power switch 116 and power switch 118. The source of power switch 118 is connected to the negative side of the power source 54 completing the switch circuit 102. In addition, capacitor 120 is connected in parallel with power switch 116 and power switch 118.

In switch circuit 104, power switch 122 and 124 are configured in electrical parallel configuration to form a half bridge circuit. Preferably, power switches 122 and 124 are N-channel MOSFETs thereby including a body diode. However, other power switches including P-channel MOSFETs and even other switch combinations such as IGBTs and the like may be utilized. The drain of power switch 122 is connected to the positive site of power source 54. The phase C machine coil 132 of the Y configuration 106 is connected to switch circuit 104 between power switch 122 and power switch 124. The source of power switch 124 is connected to the negative side of the power source 54 completing the switch circuit 104. In addition, capacitor 126 is connected in parallel with power switch 122 and power switch 124.

Switch circuits 140, 142, 144 provide the switching for phase A, B, and C, respectively, for a third Y-coil configuration 146 of the permanent magnet machine 52. In switch circuit 140, power switch 150 and 152 are in electrical parallel connection to form a half bridge configuration. Preferably, power switches 150 and 152 are N-channel MOSFETs, thereby including a body diode. However, other power switches including P-channel MOSFETs and even other complex switch combinations such as IGBTs and the like may be utilized.

The drain of power switch 70 is connected to the positive site of power source 54. The phase A machine coil 168 of the Y configuration 146 is connected to switch circuit 140 between power switch 150 and power switch 152. The source of power switch 152 is connected to the negative side of the power source 54 completing the switch circuit 140. In addition, capacitor 154 is connected in parallel with power switch 150 and power switch 152.

In switch circuit 142, power switch 156 and 158 are configured in electrical parallel configuration to form a half bridge circuit. Preferably, power switches 156 and 158 are N-channel MOSFETs thereby including a body diode. However, other power switches including P-channel MOSFETs and even other switch combinations such as IGBTs and the like may be utilized. The drain of power switch 156 is connected to the positive site of power source 54. The phase B machine coil 170 of the Y configuration 146 is connected to switch circuit 142 between power switch 156 and power switch 158. The source of power switch 158 is connected to the negative side of the power source 54 completing the switch circuit 142. In addition, capacitor 160 is connected in parallel with power switch 156 and power switch 158.

In switch circuit 144, power switch 162 and 164 are configured in electrical parallel configuration to form a half bridge circuit. Preferably, power switches 162 and 164 are N-channel MOSFETs thereby including a body diode. However, other power switches including P-channel MOSFETs and even other switch combinations such as IGBTs and the like may be utilized. The drain of power switch 162 is connected to the positive site of power source 54. The phase C machine coil 172 of the Y configuration 146 is connected to switch circuit 144 between power switch 162 and power switch 164. The source of power switch 164 is connected to the negative side of the power source 54 completing the switch circuit 144. In addition, capacitor 166 is connected in parallel with power switch 162 and power switch 164.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

1. A system for controlling a permanent magnet machine, the system comprising:
a plurality of phases located within the permanent magnet machine, each phase having a plurality of machine coils, the machine coils being spatially distributed about the motor;
a plurality of switch circuits in electrically parallel connection, each switch circuit having a first power switch in electrical series connection with a second power switch; and
wherein each switch circuit is in electrical communication with a machine coil of the plurality of machine coils.

2. The system according to claim 1, wherein each switch circuit is electrically connected with the machine coil between the first and second power switch.

3. The system according to claim 1, wherein the first and second power switches are MOSFETs.

4. The system according to claim 3, wherein the first and second power switches are N-channel MOSFETs.

5. The system according to claim 3, wherein a drain of the first power switch is connected to a source of the second power switch.

6. The system according to claim 5, further comprising a power source wherein a first side of the power source is connected to a source of the first power switch and a second side of the power source is connected to a drain of the second power switch.

7. The system according to claim 5, wherein each switch circuit includes a capacitor in electrically parallel connection with the first and second power switch.

8. The system according to claim 7, wherein the capacitor electrically connected between a source of the first power switch and a drain of the second power switch.

9. The system according to claim 8, wherein the capacitor is mounted in close proximity to the first and second power switch and configured for DC line filtering and snubbing of the switch off transients.

10. A system for controlling a permanent magnet machine, the system comprising:
a plurality of phases located within the permanent magnet machine, each phase having a plurality of machine coils, the machine coils being spatially distributed about the motor;
a plurality of switch circuits in electrically parallel connection, each switch circuit having a first power switch in electrical series connection with a second power switch, wherein each switch circuit is electrically connected to one of the plurality of machine coils between the first and second power switch.

11. The system according to claim 10, wherein the first and second power switches are MOSFETs.

12. The system according to claim 11, wherein the first and second power switches are N-channel MOSFETs.

13. The system according to claim 11, wherein a drain of the first power switch is connected to a source of the second power switch.

14. The system according to claim 13, further comprising a power source wherein a first side of the power source is connected to a source of the first power switch and a second side of the power source is connected to a drain of the second power switch.

15. The system according to claim 13, wherein each switch circuit includes a capacitor in electrically parallel connection with the first and second power switch.

16. The system according to claim 15, wherein the capacitor electrically connected between a source of the first power switch and a drain of the second power switch.

17. The system according to claim 16, wherein the capacitor is mounted in close proximity to the first and second power switch and configured for DC line filtering and snubbing of the switch off transients.
